(19) United States
(12) Patent Application Publication
(10) Pub. No.: US 2018/0093351 A1
(43) Pub. Date: Apr. 5, 2018

(54) RECESS-AND-PROTRUSION-FORMED BODY

(71) Applicant: KABUSHIKI KAISHA TOKAI-RIKA-DENKI-SEISAKUSHO, Aichi (JP)

(72) Inventors: Satoshi ITO, Aichi (JP); Takashi YUURA, Aichi (JP); Mitsuru NARUSE, Aichi (JP)

(21) Appl. No.: 15/549,873

(22) PCT Filed: Feb. 18, 2016
(86) PCT No.: PCT/JP2016/054715

§ 371 Date: Aug. 9, 2017

(30) Foreign Application Priority Data
Feb. 24, 2015 (JP) 2015-034369

(51) Int. Cl. B23K 26/354; B29C 59/16; B29C 44/56

(52) U.S. Cl. CPC B23K 26/354; B29C 49/42; B29C 44/5627; B29C 59/16

(57) ABSTRACT

In a groove-formed body, a recess and protrusions are formed on a resin plate by irradiation with a laser. When forming the recess and the protrusions on the resin plate, the laser is irradiated onto the resin plate plural times. Irradiation of the laser onto the resin plate is thus temporarily paused to cool the resin plate, enabling the portion of the resin plate irradiated by the laser to be suppressed from igniting and enabling a depth dimension of the recess and a height dimension of the protrusions to be made larger.

### TECHNICAL FIELD

The present invention relates to a recess-and-protrusion-formed body in which a protrusion is disposed at the side of a recess.

### BACKGROUND ART

In a packaging material described by Japanese Patent Application Laid-Open (JP-A) No. H10-287361, a recess is formed in a molecular-oriented thermoplastic resin layer and protrusions are formed at the sides of the recess by irradiating a laser onto the molecular-oriented thermoplastic resin layer.

In this packaging material, if the amount of irradiation by the laser onto the molecular-oriented thermoplastic resin layer were to be increased in order to increase a depth dimension of the recess and a height dimension of the protrusions, the portion of the molecular-oriented thermoplastic resin layer irradiated by the laser would rise sharply in temperature such that there is a possibility of the portion igniting.

### SUMMARY OF INVENTION

### Technical Problem

In consideration of the above circumstances, an object of the present invention is to obtain a recess-and-protrusion-formed body that enables a depth dimension of a recess and a height dimension of a protrusion to be increased.

### Solution to Problem

A recess-and-protrusion-formed body of a first aspect of the present invention includes a resin body, a recess, and a protrusion. The resin body has thermoplastic properties. The recess is formed in the resin body by a laser being irradiated onto the resin body and the resin body being cooled at at least one of a time when the laser is irradiated onto the resin body or a time when irradiation of the laser onto the resin body is paused. The protrusion is formed on the resin body at a side of the recess by forming the recess in the resin body.

A recess-and-protrusion-formed body of a second aspect of the present invention is the recess-and-protrusion-formed body of the first aspect of the present invention, wherein the resin body is left to cool when irradiation of a laser onto the resin body is paused.

A recess-and-protrusion-formed body of a third aspect of the present invention is the recess-and-protrusion-formed body of the first aspect or the second aspect of the present invention, wherein gas is emitted onto the resin body to cool the resin body.

A recess-and-protrusion-formed body of a fourth aspect of the present invention is the recess-and-protrusion-formed body of any one of the first aspect to the third aspect of the present invention, wherein a support body that supports the resin body is cooled to cool the resin body.

A recess-and-protrusion-formed body of a fifth aspect of the present invention is the recess-and-protrusion-formed body of any one of the first aspect to the fourth aspect of the present invention, wherein a space in which the resin body is disposed is cooled to cool the resin body.

### Advantageous Effects of Invention

In the recess-and-protrusion-formed body of the first aspect of the present invention, the resin body has thermoplastic properties, and the recess is formed in the resin body and the protrusion is formed at the side of the recess by the laser being irradiated onto the resin body.

The resin body is cooled at at least one of the time when the laser is irradiated onto the resin body or the time when irradiation of the laser onto the resin body is paused. This enables the portion of the resin body irradiated by the laser to be suppressed from igniting, and enables a depth dimension of the recess and a height dimension of the protrusion to be made larger.

In the recess-and-protrusion-formed body of the second aspect of the present invention, the resin body is left to cool when irradiation of the laser onto the resin body is paused. This enables the portion of the resin body irradiated by the laser to be suppressed from igniting.

In the recess-and-protrusion-formed body of the third aspect of the present invention, gas is emitted onto the resin body to cool the resin body. This enables the portion of the resin body irradiated by the laser to be suppressed from igniting.

In the recess-and-protrusion-formed body of the fourth aspect of the present invention, the support body that supports the resin body is cooled to cool the resin body. This enables the portion of the resin body irradiated by the laser to be suppressed from igniting.

In the recess-and-protrusion-formed body of the fifth aspect of the present invention, the space in which the resin body is disposed is cooled to cool the resin body. This enables the portion of the resin body irradiated by the laser to be suppressed from igniting.

### BRIEF DESCRIPTION OF DRAWINGS

FIG. 1 is a cross-section illustrating a groove-formed body according to a first exemplary embodiment of the present invention.

FIG. 2 is a cross-section illustrating formation of a groove to the groove-formed body according to the first exemplary embodiment of the present invention.

FIG. 3 is a cross-section illustrating formation of a groove to a groove-formed body according to a second exemplary embodiment of the present invention.

FIG. 4 is a cross-section illustrating formation of a groove to a groove-formed body according to a third exemplary embodiment of the present invention.

FIG. 5 is a cross-section illustrating formation of a groove to a groove-formed body according to a fourth exemplary embodiment of the present invention.

### DESCRIPTION OF EMBODIMENTS

### First Exemplary Embodiment

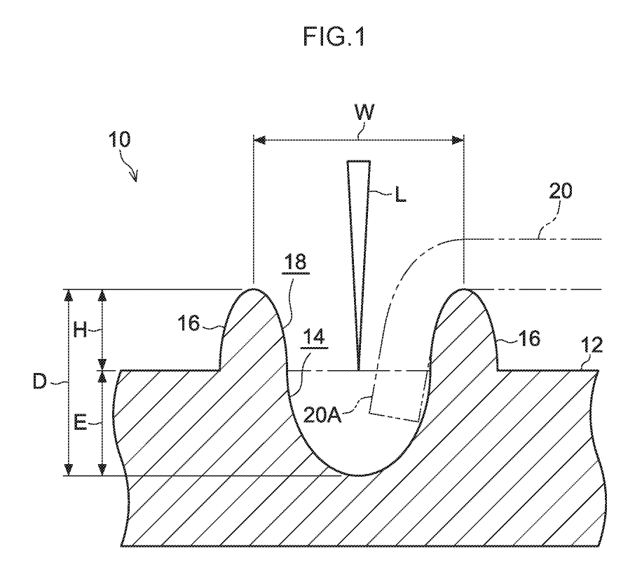

FIG. 1 is a cross-section illustrating a groove-formed body 10 (a recess-and-protrusion-formed body) according to a first exemplary embodiment of the present invention.

The groove-formed body 10 according to the present exemplary embodiment is, for example, configured as a wheel cap, this being a vehicle component. The groove-formed body 10 is attached to a vehicle width direction outside of a wheel of a vehicle (not illustrated in the drawings).

As illustrated in FIG. 1, the groove-formed body 10 includes a plate shaped resin plate 12 serving as a resin body. The resin plate 12 is configured by, for example, a PP resin, a PC resin, an ABS resin, a PC-ABS resin, or a PA resin. The resin plate 12 has thermoplastic properties. The resin plate 12 is set with a large thickness dimension of, for example, 1.5 mm, such that the resin plate 12 has high rigidity and also has high strength against cracking, bending, twisting, and the like.

A recess 14 with a substantially semielliptical shaped cross-section is formed in a front face (design face) of the resin plate 12, and the recess 14 extends along the front face of the resin plate 12. At both sides of the recess 14, a protrusion 16 with a substantially semielliptical shaped cross-section is formed on the front face of the resin plate 12. Each protrusion 16 extends along the recess 14. Thus, a groove 18 is formed in the front face of the resin plate 12, with the groove 18 being formed inside the recess 14 and between the protrusions 16. A depth dimension D of the groove 18 is configured by the sum of a depth dimension E of the recess 14 and a height dimension H of the protrusions 16. Note that, for example, the depth dimension D of the groove 18 is 0.1 mm or greater (for example, 0.1 mm), and a width dimension W (dimension between apex portions of the protrusions 16) of the groove 18 is 0.5 mm or greater (for example, 0.7 mm).

Further, a plate shaped mask 20, serving as a covering member, is mounted to the resin plate 12 from the front side prior to painting the front face of the resin plate 12, such that the mask 20 partially covers the front face of the resin plate 12. A hook portion 20A is formed at an end portion of the mask 20, and the hook portion 20A projects out toward the resin plate 12 side. Thus, the hook portion 20A catches onto the groove 18 of the resin plate 12 in a state in which the hook portion 20A is elastically deformed, thereby mounting the mask 20 onto the resin plate 12. The portion of the front face of the resin plate 12 that is covered by the mask 20 is thus restricted from being painted when the front face of the resin plate 12 is painted.

Next, explanation follows regarding operation of the present exemplary embodiment.

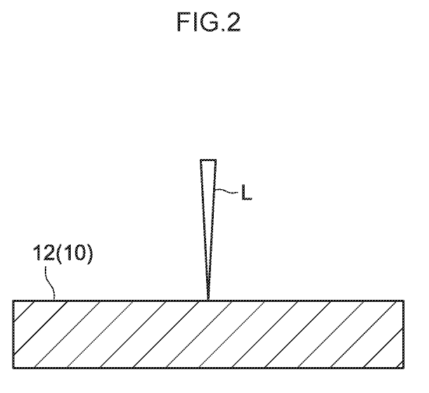

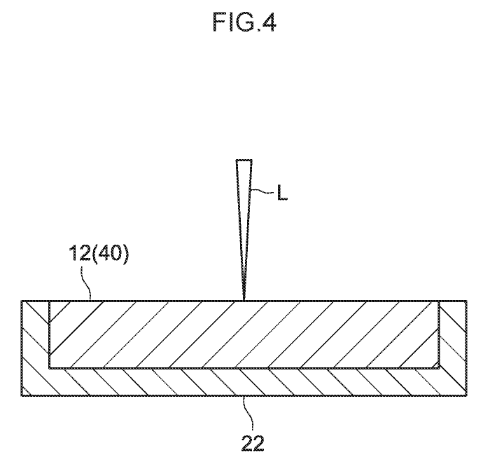

In the groove-formed body 10 configured as described above, when forming the groove 18 (the recess 14 and the protrusions 16) in the front face of the resin plate 12, as illustrated in FIG. 2, a laser L (laser light) is irradiated onto a formation position of the groove 18 in the resin plate 12 from the front side, in a state in which the resin plate 12 is supported by (fixed to) a jig 22 (see FIG. 4) serving as a support body, such that the portion of the resin plate 12 where the laser L is irradiated is heated up, thereby melting or sublimating. The portion of the resin plate 12 where the laser L is irradiated is pressed and moved toward the front side of the resin plate 12 by vapor pressure, thereby forming the recess 14 in the front face of the resin plate 12 and forming the protrusions 16 on both sides of the recess 14, such that the groove 18 is formed. Further, the laser L is scanned along the front face of the resin plate 12, thereby forming the recess 14 and the protrusions 16 continuously along the front face of the resin plate 12 so as to form the continuous groove 18.

Further, the laser L is a CO₂ laser. Moreover, the output of the laser L is, for example, no less than 1 W and no more than 10 W, and the spot diameter of the laser L is, for example, no less than 0.5 mm and no more than 2 mm The scanning speed of the laser L is, for example, 5 m/minute or more. The laser L thus heats the resin plate 12 up to a temperature that is the melting point of the resin plate 12 or greater and less than the boiling point of the resin plate 12.

Note that when forming the groove 18 in the front face of the resin plate 12, the laser L is repeatedly irradiated and scanned plural times onto the resin plate 12 (for example, three times or more) at the formation position of the groove 18. Accordingly, in the interval from when the laser L is irradiated and scanned at the formation position of the groove 18 in the resin plate 12 until the next time the laser L is irradiated and scanned at the formation position of the groove 18 in the resin plate 12, irradiation of the laser L onto the formation position of the groove 18 in the resin plate 12 is temporarily paused, and so the formation position of the groove 18 in the resin plate 12 is left to cool. Moreover, although the irradiation amount from the sum total of plural uses of the laser L onto the resin plate 12 may be large, the irradiation amount from each use of the laser L onto the resin plate 12 is small.

Accordingly, the laser L irradiated portion of the resin plate 12 can be suppressed from igniting caused by a sharp increase in temperature (overheating), and the depth dimension D of the groove 18 (the depth dimension E of the recess 14 and the height dimension H of the protrusions 16) can be made large. Thus, when the mask 20 is mounted onto the resin plate 12, the amount of catch that the hook portion 20A of the mask 20 has on the groove 18 can be increased, enabling the paint to be prevented from straying from the mask 20.

Moreover, the resin plate 12 is not only formed with the recess 14, but is also formed with the protrusions 16, configuring the groove 18 with a large depth dimension D. Thus, a reduction in the strength of the resin plate 12 against cracking, bending, twisting, and the like can be suppressed and a reduction in the rigidity of the resin plate 12 can also be suppressed.

The groove 18 (the recess 14 and the protrusions 16) is formed in the resin plate 12 after the resin plate 12 is molded in a mold. This enables the need to modify the mold in order to modify the placement, shape, and the like of the groove 18 in the resin plate 12 to be eliminated, enabling cost reduction to be realized in small-lot, multi-product production of the groove-formed body 10.

### Second Exemplary Embodiment

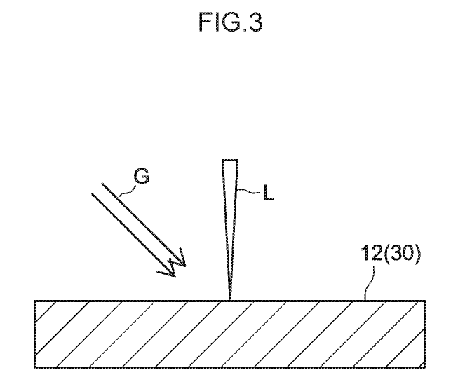

FIG. 3 is a cross-section illustrating formation of a groove 18 in a groove-formed body 30 (recess-and-protrusion-formed body) according to a second exemplary embodiment of the present invention.

The groove-formed body 30 according to the present exemplary embodiment has a similar configuration to that of the first exemplary embodiment described above, except in that formation of the groove 18 in the resin plate 12 differs in the following points.

When forming the groove 18 (a recess 14 and protrusions 16) in a front face of the resin plate 12 of the groove-formed body 30 according to the present exemplary embodiment, as illustrated in FIG. 3, cooling gas G, serving as a gas, is emitted (blown) onto the formation position of the groove 18 in the resin plate 12 (or the entirety of the resin plate 12 and a jig 22), such that the formation position of the groove 18 in the resin plate 12 is cooled (reduced in temperature). Further, the temperature of the cooling gas G is no higher than the temperature around the resin plate 12, at least prior to irradiating the laser L.

Note that the present exemplary embodiment is also capable of exhibiting operation and advantageous effects similar to those of the first exemplary embodiment described above.

In particular, as described above, the cooling gas G is emitted onto the formation position of the groove 18 in the resin plate 12 when forming the groove 18 in the front face of the resin plate 12. Thus, when the laser L is irradiated onto the resin plate 12 and when irradiation of the laser L onto the resin plate 12 is temporarily paused, the formation position of the groove 18 in the resin plate 12 is cooled by the cooling gas G This enables the laser L irradiated portion of the resin plate 12 to be effectively suppressed from igniting caused by a sharp increase in temperature (overheating), and enables the depth dimension D of the groove 18 (the depth dimension E of the recess 14 and the height dimension H of the protrusions 16) to be made even larger.

### Third Exemplary Embodiment

FIG. 4 is a cross-section illustrating formation of a groove 18 in a groove-formed body 40 (recess-and-protrusion-formed body) according to a third exemplary embodiment of the present invention.

The groove-formed body 40 according to the present exemplary embodiment has a similar configuration to that of the first exemplary embodiment described above, except in that formation of the groove 18 in the resin plate 12 differs in the following points.

When forming the groove 18 (a recess 14 and protrusions 16) in the front face of the resin plate 12 of the groove-formed body 40 according to the present exemplary embodiment, as illustrated in FIG. 4, the entirety of (or part of) a jig 22 is cooled (reduced in temperature). Further, the jig 22 entirely covers a back face and end faces of the resin plate 12, and the jig 22 is made of metal and has high thermal conductivity.

Note that the present exemplary embodiment is also capable of exhibiting operation and advantageous effects similar to those of the first exemplary embodiment described above.

In particular, as described above, the entire jig 22 is cooled when forming the groove 18 in the front face of the resin plate 12. Thus, when the laser L is irradiated onto the formation position of the groove 18 in the resin plate 12 and when irradiation of the laser L onto the resin plate 12 is temporarily paused, the resin plate 12 is cooled by cooling the jig 22. This enables the laser L irradiated portion of the resin plate 12 to be effectively suppressed from igniting caused by a sharp increase in temperature (overheating), and enables the depth dimension D of the groove 18 (the depth dimension E of the recess 14 and the height dimension H of the protrusions 16) to be made even larger.

### Fourth Exemplary Embodiment

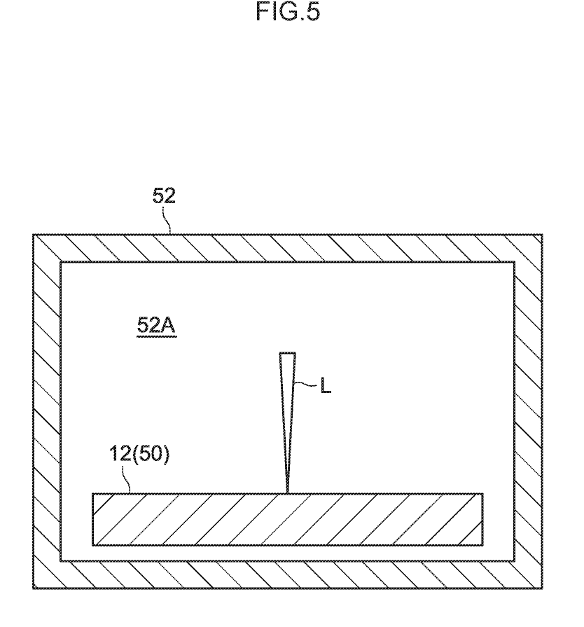

FIG. 5 is a cross-section illustrating formation of a groove 18 in a groove-formed body 50 (recess-and-protrusion-formed body) according to a fourth exemplary embodiment of the present invention.

The groove-formed body 50 according to the present exemplary embodiment has a similar configuration to that of the first exemplary embodiment described above, except in that formation of the groove 18 in the resin plate 12 differs in the following points.

When forming the groove 18 (a recess 14 and protrusions 16) in the front face of the resin plate 12 of the groove-formed body 50 according to the present exemplary embodiment, as illustrated in FIG. 5, the resin plate 12 and a jig 22 are disposed inside a cooling space 52A serving as a space in a cooling box 52, serving as a placement body. The cooling space 52A of the cooling box 52 has a sealed box shape, and peripheral walls thereof have heat insulating properties. The cooling space 52A is cooled (reduced in temperature) to a lower temperature than the temperature around the cooling box 52, at least prior to irradiating the laser L onto the resin plate 12.

Note that the present exemplary embodiment is also capable of exhibiting operation and advantageous effects similar to those of the first exemplary embodiment described above.

In particular, as described above, when forming the groove 18 into the front face of the resin plate 12, the resin plate 12 and the jig 22 are disposed in the cooling space 52A of the cooling box 52. Thus, when the laser L is irradiated onto the formation position of the groove 18 in the resin plate 12 and when irradiation of the laser L onto the resin plate 12 is temporarily paused, the resin plate 12 is cooled by cooling the cooling space 52A. This enables the laser L irradiated portion of the resin plate 12 to be effectively suppressed from igniting caused by a sharp increase in temperature (overheating), and enables the depth dimension D of the groove 18 (the depth dimension E of the recess 14 and the height dimension H of the protrusions 16) to be made even larger.

Note that in the second exemplary embodiment to the fourth exemplary embodiment described above, the laser L is irradiated and scanned plural times at the formation position of the groove 18 in the resin plate 12. However, the laser L may be irradiated and scanned at the formation position of the groove 18 in the resin plate 12 a single time with an increased irradiation amount.

Further, in the first exemplary embodiment to the fourth exemplary embodiment described above, the laser L is repeatedly irradiated and scanned plural times at the formation position of the groove 18 in the resin plate 12. However, each time the laser L is irradiated and scanned onto the resin plate 12, the position at which the laser L is irradiated and scanned onto the resin plate 12 may be shifted by a predetermined interval (for example, 0.1 mm).

Moreover, in the first exemplary embodiment to the fourth exemplary embodiment described above, the laser L is irradiated and scanned plural times at the formation position of the groove 18 in the resin plate 12. However, irradiation of the laser L onto the resin plate 12 may be temporarily paused partway through the laser L irradiating and scanning the formation position of the groove 18 in the resin plate 12. When irradiation of the laser L onto the resin plate 12 is temporarily paused in such cases, scanning by the laser L may also be temporarily paused, and moreover, the laser L may be irradiated and scanned at the formation position of the groove 18 in the resin plate 12 a single time with an increased irradiation amount.

Further, in the first exemplary embodiment to the fourth exemplary embodiment described above, an exothermic material (for example, carbon black) that absorbs the laser L and heats up may be mixed into the resin plate 12.

Moreover, in the first exemplary embodiment to the fourth exemplary embodiment described above, the laser L is a CO₂ laser. However, the laser L may be a YGA laser, a YVO₄ laser, a fiber laser, a semiconductor laser, or a second harmonic laser generated from any these.

The disclosure of Japanese Patent Application No. 2015-34369 filed on Feb. 24, 2015 is incorporated in its entirety by reference herein.

### EXPLANATION OF THE REFERENCE NUMERALS

10 groove-formed body (recess-and-protrusion-formed body)
12 resin plate formed body (resin body)
14 recess
16 protrusion
22 jig (support body)
30 groove-formed body (recess-and-protrusion-formed body)
40 groove-formed body (recess-and-protrusion-formed body)
50 groove-formed body (recess-and-protrusion-formed body)
52A cooling space (space)
G cooling gas (gas)
L laser

1. A recess-and-protrusion-formed body comprising:
a resin body having thermoplastic properties;
a recess that is formed in the resin body by a laser being irradiated onto the resin body and the resin body being cooled at at least one of a time when the laser is irradiated onto the resin body or a time when irradiation of the laser onto the resin body is paused; and
a protrusion that is formed on the resin body at a side of the recess by forming the recess in the resin body.

2. The recess-and-protrusion-formed body of claim 1, wherein the resin body is left to cool when irradiation of the laser onto the resin body is paused.

3. The recess-and-protrusion-formed body of claim 1, wherein a gas is emitted onto the resin body to cool the resin body.

4. The recess-and-protrusion-formed body of claim 1, wherein a support body that supports the resin body is cooled to cool the resin body.

5. The recess-and-protrusion-formed body of claim 1, wherein a space in which the resin body is disposed is cooled to cool the resin body.

6. The recess-and-protrusion-formed body of claim 1, wherein the laser is irradiated onto the resin body a plurality of times.

7. The recess-and-protrusion-formed body of claim 1, wherein a laser is repeatedly irradiated onto the resin body a plurality of times so as to overlap.

8. The recess-and-protrusion-formed body of claim 1, wherein the recess and the protrusion are formed on the resin body after the resin body has been molded in a mold.

9. The recess-and-protrusion-formed body of claim 1, wherein an exothermic material that absorbs a laser and heats up is mixed into the resin body.
